(19) United States
(12) Patent Application Publication
(10) Pub. No.: US 2020/0086832 A1
(43) Pub. Date: Mar. 19, 2020

(54) WASHING DEVICE

(71) Applicant: TOYODA GOSEI CO., LTD., Kiyosu-shi (JP)

(72) Inventors: Hitoshi HORIBE, Kiyosu-shi (JP); Takeshi KONDO, Kiyosu-shi (JP)

(21) Appl. No.: 16/535,290

(22) Filed: Aug. 8, 2019

(30) Foreign Application Priority Data
Sep. 19, 2018 (JP) 2018-174485

(51) Int. Cl. B60S 1/52; B08B 3/02; B60S 1/56; G02B 27/00

(52) U.S. Cl. CPC B60S 1/528; G02B 27/0006; B60S 1/56; B08B 3/02

(57) ABSTRACT

A washing device includes a nozzle portion reciprocally movable between an accommodating position and a washing position. The washing device is configured to wash a surface of an external washing target by supplying fluid to the nozzle portion, moving the nozzle portion from the accommodating position to the washing position using pressure of the fluid, and spraying the fluid from a spray port of the nozzle portion onto the surface of the washing target. The nozzle portion is configured to reciprocate along one of a curved path and a bent path between the accommodating position and the washing position.

### BACKGROUND

### 1. Field

The present disclosure relates to a washing device for washing a washing target.

### 2. Description of Related Art

Techniques of autonomous driving employing a camera are now broadly known. The camera is mounted in vehicles as an optical sensor. During such autonomous driving, camera images are analyzed to recognize the surrounding conditions. Such operation requires clear camera images and thus may cause low accuracy in case of camera lens surface contamination. For this reason, employing a washing device for such autonomous-driving vehicles has been contemplated. The washing device is capable of spraying fluid such as water to decontaminate the lens surface (see Japanese Laid-Open Patent Publication No. 2007-53448).

One such washing device is configured to project a nozzle section through piston actuation for washing. However, such configuration requires great accommodation space for the washing device, which may limit flexibility in installment of the washing device.

### SUMMARY

Accordingly, it is an objective of the present disclosure to provide a washing device capable of reducing its size.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a washing device is provided that includes a nozzle portion reciprocally movable between an accommodating position and a washing position. The washing device is configured to wash a surface of an external washing target by supplying fluid to the nozzle portion, moving the nozzle portion from the accommodating position to the washing position using pressure of the fluid, and spraying the fluid from a spray port of the nozzle portion onto the surface of the washing target. The nozzle portion is configured to reciprocate along one of a curved path and a bent path between the accommodating position and the washing position.

Other features and aspects will be apparent from the following detailed description, the drawings, and the claims.

### BRIEF DESCRIPTION OF THE DRAWINGS

FIG. 1A is a schematic diagram showing a rear section of a vehicle including a washing device according to a first embodiment at the time a nozzle portion is located at the accommodating position.

FIG. 1B is a schematic diagram showing the nozzle portion of FIG. 1A when located at the washing position.

FIG. 2A is a cross-sectional view showing the washing device when located at the accommodating position.

FIG. 2B is a cross-sectional view showing the washing device when located at the washing position.

FIG. 3 is an exploded perspective view showing the washing device.

FIG. 4 is an exploded perspective view showing a washing device according to a second embodiment.

FIG. 5 is a perspective view showing the washing device.

FIG. 6A is a schematic diagram showing the nozzle portion when located at the accommodating position.

FIG. 6B is a schematic diagram showing the nozzle portion when located at the washing position.

FIG. 7A is a side view showing the nozzle portion when located at the accommodating position.

FIG. 7B is a side view showing the nozzle portion when located at the washing position.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

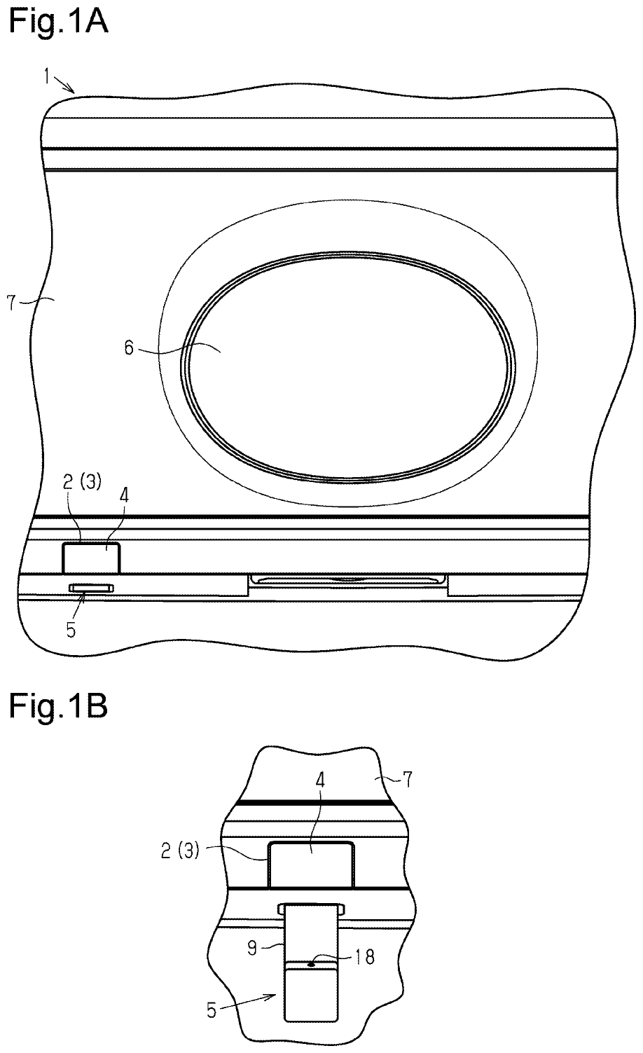

A washing device 5 according to a first embodiment will now be described with reference to FIGS. 1A to 3.

As illustrated in FIGS. 1A and 1B, a vehicle 1 has a camera 3 (a rear camera), which is a washing target 2, and a washing device 5. Specifically, the camera 3 is disposed in a rear body section and the washing device 5 is arranged in the vicinity of the camera 3. More specifically, the washing device 5 is located in a lower section of a garnish 7 having an emblem 6 of the vehicle 1. The washing device 5 washes a lens surface 4 of the camera 3. The camera 3 captures images of the surroundings that are necessary for autonomous driving, as well as images that should be displayed on the in-car monitor at the time the vehicle 1 is reversed.

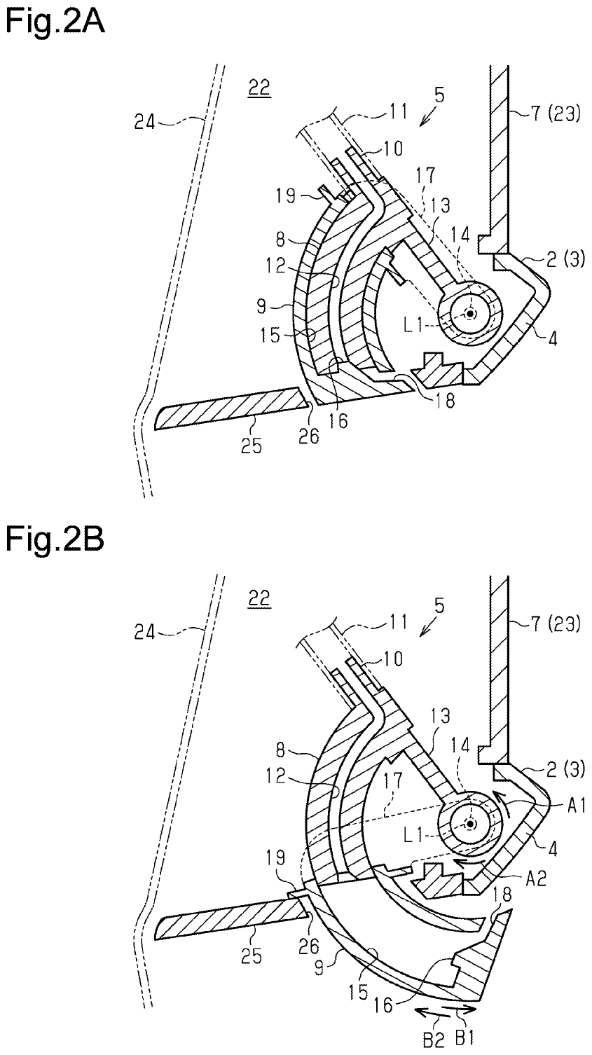

With reference to FIGS. 2A and 2B, the washing device 5 includes a tubular portion 8 and a nozzle portion 9. Fluid is introduced into the tubular portion 8. The pressure of the fluid projects the nozzle portion 9 from the tubular portion 8, thus spraying the fluid onto the lens surface 4 of the camera 3. That is, the washing device 5 is configured to selectively extend and retract the nozzle part (the tubular portion 8 and the nozzle portion 9).

The tubular portion 8 has a curved shape. A pipe attachment portion 10 is formed in one end of the tubular portion 8. A pipe portion 11 is connected to the pipe attachment portion 10 to supply fluid. A flow passage 12 for the fluid extends through the tubular portion 8. The flow passage 12 is defined by a curved path shaped to conform to the outline of the tubular portion 8. An extended piece 13 is formed on a wall surface of the tubular portion 8 and extends in a direction crossing the tubular portion 8. Two shaft portions 14 are arranged at the distal end of the extended piece 13 and support the nozzle portion 9 such that the nozzle portion 9 is pivotal about the axis L1.

The nozzle portion 9 has such a curved shape to be fitted to the tubular portion 8. A hole 15 is formed in the nozzle portion 9. The nozzle portion 9 is arranged around the tubular portion 8 such that the tubular portion 8 is received in the hole 15. A projection 16 is formed on the bottom surface of the hole 15 and closes the flow passage 12 when the nozzle portion 9 is located at an accommodating portion. Two arm portions 17 are formed on a wall surface of the nozzle portion 9 and each extend in a direction crossing the nozzle portion 9. The distal ends of the arm portions 17 are supported by the shaft portions 14 of the tubular portion 8. A spray port 18 is formed in the distal end of the nozzle portion 9 and supplies fluid from the nozzle portion 9 to the outside. A stopper portion 19 projects from the basal end of the nozzle portion 9 and positions the nozzle portion 9 at a washing position.

An accommodating portion 22 is arranged on the backside of the lens surface 4, which is the washing target 2. The washing device 5 (the nozzle portion 9) is located in the accommodating portion 22. The accommodating portion 22 is defined by the region surrounded by an outer wall 23 and an inner wall 24. The lens surface 4, which is the washing target 2, is attached to the outer wall 23. The inner wall 24 extends upright to be opposed to the back surface of the outer wall 23. In the first embodiment, the outer wall 23 corresponds to the garnish 7. The inner wall 24 is formed by a metal plate arranged in the vehicle 1. The camera 3 is attached to the garnish 7 with the lens surface 4 exposed to the outside. A bottom wall 25 is disposed below the garnish 7 and extends in a horizontal direction of the vehicle body. The bottom wall 25 configures the bottom section of the accommodating portion 22. An open hole 26 extends through the bottom wall 25. The nozzle portion 9 is exposed from the open hole 26.

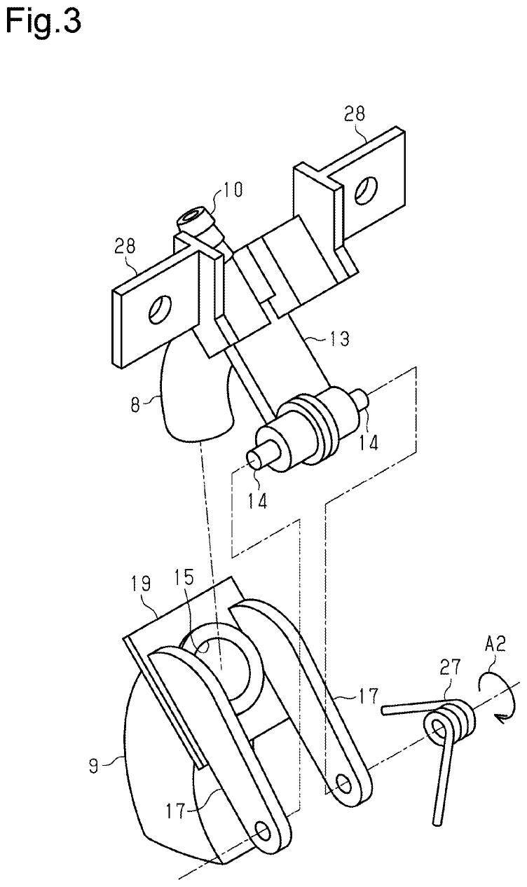

Referring to FIG. 3, the washing device 5 includes an urging portion 27. The urging portion 27 applies urging force to the nozzle portion 9 to return the nozzle portion 9 from the washing position to the accommodating position. In the first embodiment, the urging portion 27 is formed by, for example, a torsion spring. The urging portion 27 is disposed between the tubular portion 8 and the nozzle portion 9 to urge the nozzle portion 9 in the returning direction (as indicated by arrow A2 in FIG. 3).

The tubular portion 8 has two plate-like attachment pieces 28 and is attached to the vehicle body by means of the attachment pieces 28. The attachment pieces 28 are located on the left and right sides of the tubular portion 8 (the extended piece 13). The tubular portion 8 is fixed to the vehicle body by attaching the attachment pieces 28 to the vehicle body using fasteners such as bolts (not shown). Two shaft portions 14 project from the distal end of the extended piece 13 of the tubular portion 8. The arm portions 17 of the nozzle portion 9 are pivotally attached to the shaft portions 14.

The operation and advantages of the washing device 5 of the first embodiment will now be described with reference to FIGS. 1A to 2B.

When fluid is not supplied to the washing device 5 (the tubular portion 8), the nozzle portion 9 of the washing device 5 does not receive the pressure of the fluid. Therefore, as shown in FIGS. 1A and 2A, the nozzle portion 9 is located at the accommodating position and thus arranged around the tubular portion 8. When at the accommodating position, the nozzle portion 9 is hidden on the backside of the garnish 7. The nozzle portion 9 is thus invisible even if the washing device 5 is viewed from the rear side of the vehicle body. This ensures an aesthetic appearance.

The fluid is supplied to the washing device 5 (the tubular portion 8) using, for example, a pump (not shown) of the washing device 5. At this stage, the pressure of the fluid supplied to the tubular portion 8 pivots the nozzle portion 9 about the shaft portions 14 in the projecting direction (as indicated by arrow A1 in FIG. 2B). The nozzle portion 9 thus moves relative to the tubular portion 8. At this stage, the nozzle portion 9 moves in the projecting direction (as indicated by arrow B1 in FIG. 2B) along the curved path with respect to the tubular portion 8. The nozzle portion 9 thus moves to a maximally projecting position, which is the position at which the stopper portion 19 contacts the bottom wall 25, and reaches the washing position. With reference to FIGS. 1B and 2B, when the nozzle portion 9 is located at the washing position, the spray port 18 faces upward. After the nozzle portion 9 reaches the washing position, the pressure of the fluid sprays the fluid from inside the hole 15 to the outside through the spray port 18. The fluid then washes the lens surface 4.

After a predetermined amount of fluid is supplied to the washing device 5, the pump of the washing device 5 is deactivated. When the supply of fluid is stopped, the pressure of the fluid gradually decreases. As the fluid pressure decreases, the urging force of the urging portion 27 pivots the nozzle portion 9 about the shaft portions 14 in the returning direction (as indicated by arrow A2 in FIG. 2B). The nozzle portion 9 thus moves relative to the tubular portion 8. As a result, the nozzle portion 9 moves along the curved path in the returning direction (as indicated by arrow B2 in FIG. 2B) and thus returns to the accommodating position, at which the nozzle portion 9 has been originally located.

In the first embodiment, the movement path of the nozzle portion 9 from the accommodating position to the washing position is defined by the curved path. This reduces the size of the space necessary for mounting the nozzle portion 9. The washing device 5 thus becomes compact.

When at the accommodating position, the nozzle portion 9 is located in the accommodating portion 22, which is arranged on the backside of the lens surface 4, which is the washing target 2. When the nozzle portion 9 projects from the accommodating portion 22 and is located at the washing position, the spray port 18 is located outward of the lens surface 4 and thus capable of washing the lens surface 4. Therefore, by projecting the nozzle portion 9 from the backside of the lens surface 4 to the washing position when necessary, the lens surface 4 is washed by the nozzle portion 9 from a position in the vicinity of the lens surface 4.

The accommodating portion 22 is defined by the region surrounded by the garnish 7, to which the camera 3 is attached, and the inner wall 24, which extends upright as opposed to the back surface of the garnish 7. The washing device 5 thus can be arranged in the accommodating portion 22, which is a limited space in the region surrounded by the garnish 7 and the inner wall 24, which is located in the backside of the garnish 7.

When the nozzle portion 9 is located at the accommodating position, the nozzle portion 9 is hidden by the garnish 7. This ensures the aesthetic appearance of the washing device 5.

The washing target 2 is the camera 3 and the nozzle portion 9 washes the surface of the camera 3 (the lens surface 4) using fluid. In this manner, the washing device 5 decontaminates the surface of the camera 3 (the lens surface 4), thus ensuring a desirable output of the camera 3.

The washing device 5 includes the tubular portion 8, the nozzle portion 9, and the urging portion 27. The nozzle part is thus selectively extended and retracted, or, in other words, the nozzle portion 9 is moved relative to the tubular portion 8. This further contributes to the size reduction of the washing device 5.

### Second Embodiment

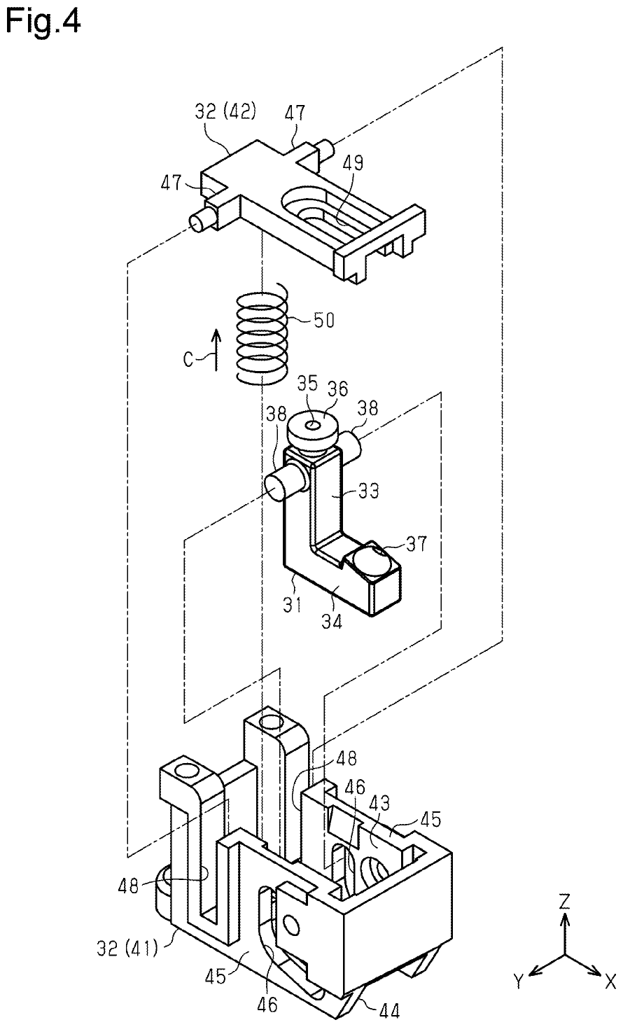

A second embodiment will now be described with reference to FIGS. 4 to 7B. The second embodiment is different from the first embodiment in the structure of the washing device 5. Therefore, the same reference numerals are given to those components that are the same as the corresponding components of the first embodiment, and the differences from the first embodiment will be described below.

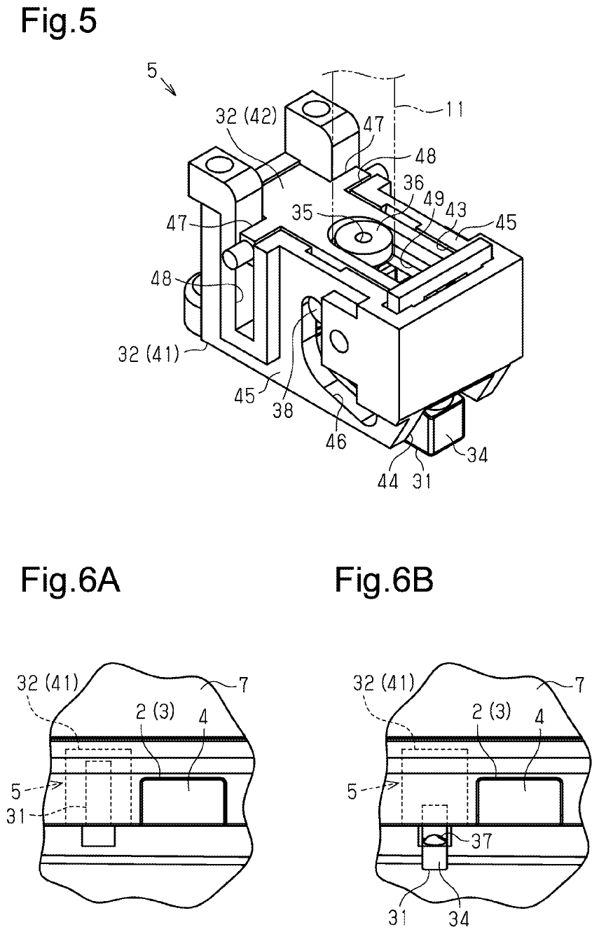

As shown in FIGS. 4 and 5, the washing device 5 includes a nozzle portion 31 and a device body 32. The nozzle portion 31 is connected to the pipe portion 11 (see FIG. 5), which supplies fluid. The device body 32 supports the nozzle portion 31 such that the nozzle portion 31 is movable between an accommodating position and a washing position. That is, the washing device 5 of the second embodiment is configured such that the nozzle part is formed by a single component (the nozzle portion 31) and the nozzle portion 31 moves relative to the device body 32.

The nozzle portion 31 includes a body portion 33 and a distal section 34. The body portion 33 extends in the height direction of the washing device 5 (in Z-axis direction in FIG. 4). The distal section 34 extends in a direction crossing the body portion 33. In the second embodiment, the body portion 33 and the distal section 34 extend in mutually perpendicular directions. The nozzle portion 31 is thus substantially L-shaped. A flow passage 35 is formed in the interior of the nozzle portion 31. The flow passage 35 is substantially L-shaped to conform to the outline of the nozzle portion 31. A head portion 36 is disposed on an end of the body portion 33. The pipe portion 11 is connected to the head portion 36. A spray port 37 is formed in the distal section 34. Two guide projections 38 are formed on the opposite side surfaces of the nozzle portion 31 to guide the nozzle portion 31 to move along a curved path.

The device body 32 includes a housing 41 and a middle member 42. The housing 41 has a recess 43. The middle member 42 is disposed between the nozzle portion 31 and the housing 41. The nozzle portion 31 is movably accommodated in the recess 43 of the housing 41. When located at the washing position, the nozzle portion 31 is exposed from an opening 44 in the bottom of the recess 43. The housing 41 has two side walls 45. Each of the side walls 45 has a guide 46 to guide the nozzle portion 31 along the curved path. Each of the guides 46 is substantially L-shaped.

The middle member 42 is shaped substantially like a plate. The middle member 42 is mounted in the recess 43 of the housing 41 such that the nozzle portion 31 is located between the housing 41 and the middle member 42. The middle member 42 has two side walls each having a guide projection 47. The guide projections 47 guide the middle member 42 to move in the height direction of the washing device 5 (in Z-axis direction in FIG. 4). Each of the side walls 45 of the housing 41 has a slit 48. The guide projections 47 are fitted to the slits 48. The middle member 42 has a stepped elongated hole 49. The head portion 36 of the nozzle portion 31 is received in the elongated hole 49 to be movable relative to the elongated hole 49 in the longitudinal direction of the elongated hole 49. When the middle member 42 slides in the up-down direction, the elongated hole 49 allows the nozzle portion 31 to move along the curved path. In this manner, the nozzle portion 31 and the middle member 42 move integrally with each other.

An urging portion 50 is located between the housing 41 and the middle member 42 and accommodated in the recess 43 of the housing 41. In the second embodiment, the urging portion 50 is formed by a coil spring and urges the middle member 42 in a pressing manner in the returning direction (as indicated by arrow C in FIG. 4).

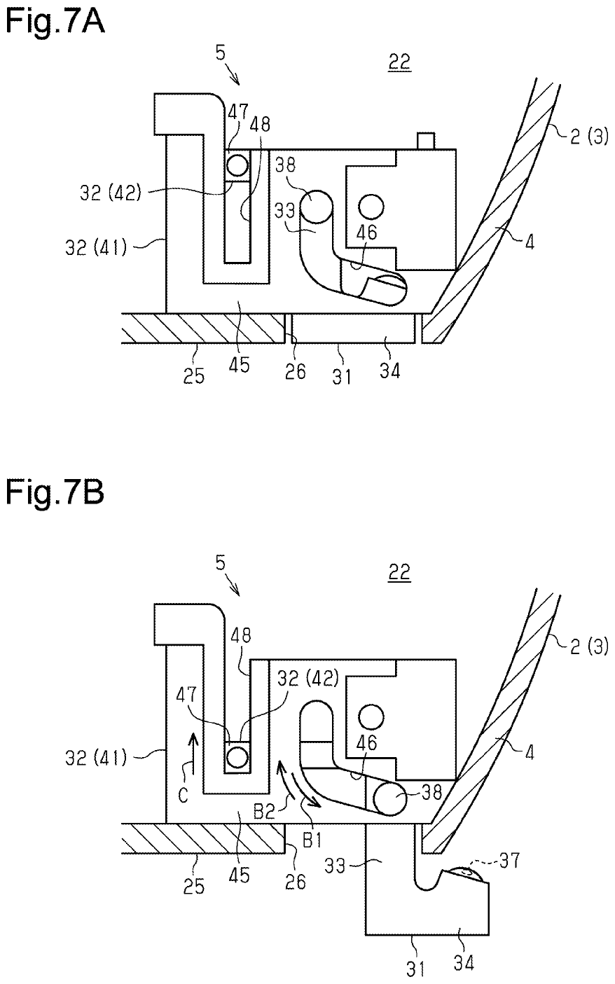

The operation and advantages of the washing device 5 of the second embodiment will now be described with reference to FIGS. 6A to 7B.

When fluid is not supplied to the washing device 5 (the nozzle portion 31), the nozzle portion 31 does not receive the pressure of the fluid. Therefore, with reference to FIGS. 6A and 7A, the washing device 5 is located at an accommodating position at which the nozzle portion 31 is received in the housing 41. When at the accommodating position, the nozzle portion 31 is hidden on the backside of the garnish 7. The nozzle portion 31 is thus invisible even if the washing device 5 is viewed from the rear side of the vehicle body. This ensures the aesthetic appearance.

The fluid is supplied to the washing device 5 (the nozzle portion 31) using, for example, a pump (not shown) of the washing device 5. In the second embodiment, when the fluid is supplied to the washing device 5 (the nozzle portion 31), the nozzle portion 31 is moved by the pressure of the fluid flowing into the pipe portion 11 in the projecting direction (as indicated by arrow B1 in FIG. 7B) along the curved path with respect to the housing 41 while being guided by the guide projections 38 and the guides 46. At this stage, the nozzle portion 31 moves to a maximally projecting position, which is the position at which the guide projections 38 contact the finishing ends of the guides 46, and reaches the washing position. With reference to FIGS. 6B and 7B, when the nozzle portion 31 is located at the washing position, the spray port 37 faces diagonally upward. After the nozzle portion 31 reaches the washing position, the pressure of the fluid sprays the fluid from inside the nozzle portion 31 to the outside through the spray port 37. The fluid then washes the lens surface 4.

After a predetermined amount of fluid is supplied to the washing device 5, the pump of the washing device 5 is deactivated and the fluid supply is stopped. Then, the pressure of the fluid gradually decreases. As the fluid pressure decreases, the urging force of the urging portion 50 presses the middle member 42 in the returning direction (as indicated by arrow C in FIG. 7B). The nozzle portion 31 thus moves relative to the housing 41. As a result, the nozzle portion 31 moves along the curved path in the returning direction (as indicated by arrow B2 in FIG. 7B) and thus returns to the accommodating position at which the nozzle portion 31 has been originally located.

In the second embodiment, the washing device 5 includes the nozzle portion 31, the device body 32, and the urging portion 50. The nozzle part is thus configured by a single component (the nozzle portion 31). This contributes to the simplified configuration of the device.

The above-described embodiments may be modified as follows. The above-described embodiments and the following modifications can be combined as long as the combined modifications remain technically consistent with each other.

In the first embodiment, the nozzle portion 9 does not necessarily have to be arranged around the tubular portion 8 and may be fitted to the interior of the tubular portion 8.

In the first embodiment, the cross-sectional shape of the tubular portion 8 does not necessarily have to be circular and may be modified to any other shape including a rectangular shape. In this case, the nozzle portion 9 must also be modified to a matching shape with the tubular portion 8.

In each of the embodiments, the fluid may be, for example, water or compressed air or a mixture of water and compressed air. Any fluid may be employed as long as the washing target can be washed using the fluid.

In each embodiment, the washing device 5 does not necessarily have to be configured to spray fluid from below through the nozzle portion 9, 31 onto the washing target 2. That is, for example, the washing device 5 may have such a configuration that the nozzle portion 9, 31 is located above the washing target 2 when at the washing position, thus spraying fluid onto the washing target 2 from above.

In each embodiment, the nozzle portion 9, 31 may be shaped in various manners as long as the nozzle portion 9, 31 is capable of spraying fluid onto the washing target 2 when the nozzle portion 9, 31 is located at the washing position.

In each embodiment, the nozzle portion 9, 31 may have a section exposed to the outside when located at the accommodating position.

In each embodiment, the washing device 5 does not necessarily have to be located on the backside of the camera 3 (the lens surface 4). For example, the location of the washing device 5 may be changed to any other positions such as a position below the camera 3 (the lens surface 4).

In each embodiment, the accommodating portion 22 does not necessarily have to be defined by the region (space) surrounded by the garnish 7 and the inner wall 24 on the backside of the garnish 7. The accommodating portion 22 may be any section as long as the section can receive the washing device 5. That is, various components may replace the outer wall 23 and the inner wall 24 as the components of the accommodating portion 22.

In each embodiment, the washing device 5 does not necessarily have to be accommodated on the backside of the garnish 7 and may be located at any other position than the position on the backside of the garnish 7.

In each embodiment, the washing device 5 does not necessarily have to be located forward of the washing target 2 in the vehicle front-rear direction and may be located rearward of the washing target 2.

In each embodiment, the washing target 2 is not restricted to the camera 3 (the lens surface 4) and may be any component that needs washing such as a sensor.

In each embodiment, it is preferable that the pipe portion 11 be a flexible component.

In each embodiment, the washing device 5 does not necessarily have to be employed in the vehicle 1 and may be used in any other devices.

In each embodiment, the movement path of the nozzle portion 9, 31 between the accommodating position and the washing position is not restricted to a curved path and may be, for example, a bent path.

The washing device 5 is not restricted to the configurations of the above-described embodiments and may be configured in any other manner as long as the nozzle portion 9, 31 moves along a curved path or a bent path.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A washing device comprising a nozzle portion reciprocally movable between an accommodating position and a washing position, wherein
the washing device is configured to wash a surface of an external washing target by supplying fluid to the nozzle portion, moving the nozzle portion from the accommodating position to the washing position using pressure of the fluid, and spraying the fluid from a spray port of the nozzle portion onto the surface of the washing target, and
the nozzle portion is configured to reciprocate along one of a curved path and a bent path between the accommodating position and the washing position.

2. The washing device according to claim 1, wherein
when the nozzle portion is located at the accommodating position, the nozzle portion is located in an accommodating portion arranged on a backside of the washing target, and
when the nozzle portion is located at the washing position, the spray port is located outward of the surface of the washing target such that the nozzle portion is capable of washing the surface of the washing target.

3. The washing device according to claim 2, wherein the accommodating portion is defined by a region surrounded by an outer wall to which the washing target is attached with the surface of the washing target exposed to the outside and an inner wall that extends upright to be opposed to a back surface of the outer wall.

4. The washing device according to claim 1, wherein, when the nozzle portion is located at the accommodating position, the nozzle portion is hidden by an outer wall to which the washing target is attached with the surface of the washing target exposed to the outside.

5. The washing device according to claim 1, wherein
the washing target is one of a camera and a sensor, and
the nozzle portion washes a surface of one of the camera and the sensor using the fluid.

6. The washing device according to claim 1, further comprising:
a curved tubular portion connected to a pipe portion that supplies the fluid; and
an urging portion that applies, to the nozzle portion, an urging force for returning the nozzle portion from the washing position to the accommodating position, wherein
the nozzle portion has a curved shape fittable to the tubular portion, and
the nozzle portion is configured such that, when the nozzle portion is at the accommodating position and supplied with the fluid, the nozzle portion moves in a manner projecting from the tubular portion along one of the curved path and the bent path to reach the washing position and spray the fluid from the spray port.

7. The washing device according to claim 1, further comprising:
a device body that supports the nozzle portion such that the nozzle portion is movable between the accommodating position and the washing position; and
an urging portion that applies, to the nozzle portion, an urging force for returning the nozzle portion from the washing position to the accommodating position, wherein
the nozzle portion is connected to a pipe portion that supplies the fluid, and
the nozzle portion is configured such that, when the nozzle portion is at the accommodating position and supplied with the fluid, the nozzle portion moves along one of the curved path and the bent path to reach the washing position and spray the fluid from the spray port.
